(19) United States
(12) Patent Application Publication
(10) Pub. No.: US 2007/0109283 A1
(43) Pub. Date: May 17, 2007

(54) Display apparatus for conveyor

(75) Inventor: Atsushi Maeda, Hyogo-Ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Elevator Kabushiki Kaisha, Tokyo (JP)

(21) Appl. No.: 10/575,179

(22) PCT Filed: Oct. 8, 2004
(86) PCT No.: PCT/JP04/15303

§ 371 Date: Jan. 16, 2007

(30) Foreign Application Priority Data
Oct. 10, 2003 (JP) 2003-352658

(51) Int. Cl. G09G 5/00

(52) U.S. Cl. 345/204

(57) ABSTRACT

A display device for conveyor according to the present invention: a plurality of safety device disposed on various points of a conveyor; a display for displaying information such as operation conditions of the conveyor or broken locations thereof by means of predetermined display patterns; a contactor for intermittently charging current to a motor driving part of the conveyor, or switching UP and DOWN operations; a safety device operation detection relay for blocking a power source of the contactor, when any of the safety devices is operated; a binarization means for binarizing a signal which specifies the operation condition of the conveyor or the operated safety device; and a display controller for receiving the binarized signal, determining a message to be displayed in compliance with a combination of binary signals, and outputting the determined display signal to the display device.

### BACKGROUND OF THE INVENTION

1. Field of the Invention

The present invention relates to a conveyor. More particularly, it relates to a display apparatus for a conveyor.

2. Background Art

In recent years, conveyors have been introduced progressively in public gathering places such as train stations and airports, shopping centers, department stores, and hotels in order to prepare for an coming aged society.

Such a conveyor provided with a display device for showing a sign to indicate a moving direction of the conveyor or a sign to inform that no passengers are allowed to board the conveyor. The conveyor also has safety devices disposed on various points which detect malfunctions of equipments and suspend an operation of the conveyor. The operation condition display device is generally disposed on an end of a handrail panel so as to be recognized by a passenger on a platform.

Japanese Patent Laid-Open Publication No. 201682/1993 shows an example of a conventional operation condition display device used in a conveyor.

In a conventional display device, each of indicating items shown on a display corresponds to signal transmitting lines of the safety devices respectively. Thus, when the number of detection point is increased, or the number of displayed messages indicating operation conditions is increased, for example, the number of signal transmitting lines is also inevitably increased. The growing number of signal transmitting lines causes an increase of input circuits of the display device, which complicates a structure of the display device and is thus inefficient.

In addition, when an operation control unit for controlling an operation of a conveyor has gone wrong, there may be a case where a backup function does not work so that a misinformation signal is sent to the display device and thus a wrong message is displayed.

### SUMMARY OF THE INVENTION

Therefore, an object of the present invention is to provide a display apparatus for a conveyor that can eliminate the above disadvantages of the conventional art, and can increase the number of items to be displayed by means of the less number of signal wires so as to convey more messages to passengers and maintenance workers.

In order to achieve the above object, the invention according to claim 1 is a display apparatus for a conveyor comprises a plurality of safety devices disposed on a conveyor; a display configured to indicate information relating to operational conditions of the conveyor or positions of a malfunctioned safety device; a contactor for intermittently charging to a motor driving circuit of the conveyor, or changing running operation between normal and reverse running directions; a safety device detector means configured to be capable shutting down a power source of the contactor, when any of the safety devices is actuated; and a display controller configured to specify the operation condition of the conveyor or the actuated safety device, and providing the information to the display.

The invention according to claim 2 is a display device for a conveyor comprising; a plurality of safety devices disposed on a conveyor; a display configured to indicate information relating to operational conditions of the conveyor or positions of a malfunctioned safety device; a contactor for intermittently charging to a motor driving circuit of the conveyor, or changing running operation between normal and reverse running directions; a safety device detector configured to be capable shutting down a power source of the contactor, when any of the safety devices is actuated; a binary signal means configured to generate a binary signal which specifies the operation condition of the conveyor or the actuated safety device; and a display controller configured to determine a indication to be displayed in compliance with a combination of introduced binary signals, and providing the display signal to the display.

The invention according to claim 3 is the display device for a conveyor according to claim 2, wherein the binarizing means includes a controller for outputting to the display controller the binary signals specifying the positions of the actuated safety device based on potentials of the respective safety devices, the controller also serving for controlling an operation of the conveyor; and a contact which is opened and closed in conjunction with ON/OFF of the contactor, and is connected to an input of the display controller.

The invention according to claim 4 is the display device for a conveyor according to claim 3 further comprising: a signal interrupting means for Interrupting all the signals to be delivered to the display controller, upon a detection of an malfunction of the controller.

The invention according to claim 5 is the display device for a conveyor according to claim 4, wherein the signal interrupting means sends a signal informing of the malfunction to a monitoring panel, simultaneously with interrupting the signals.

The invention according to claim 6 is the display device for a conveyor according to claim 1 or 2, wherein the display controller has a function for encrypting a indication to be displayed.

The invention according to claim 7 is the display device for a conveyor according to claim 3, wherein the controller has a storing means for storing malfunction data.

The invention according to claim 8 is the display device for a conveyor according to claim 7, wherein the controller has a battery as an emergency power.

In accordance with the present invention, a lot of messages can be displayed in compliance with a combination of binary signals, without increasing the number of signal wires. Since the number of items to be displayed can be increased, more messages can be conveyed to passengers and maintenance workers.

### BRIEF DESCRIPTION OF THE DRAWINGS

FIG. 1 is a circuit diagram of a first embodiment of a display apparatus for a conveyor according to the present invention;

FIG. 2 is a circuit diagram of a contactor disposed on a driving part of a conveyor;

FIG. 3 is a reference chart showing a relation between a combination of binary signals and messages to be displayed;

FIGS. 4(A) to 4(C) are examples of displayed messages;

FIG. 5 is a perspective view of a platform and its vicinity of a conveyor to which the present invention is applied; and

FIG. 6 is a circuit diagram of a second embodiment of a display apparatus for a conveyor according to the present invention.

### DETAILED DESCRIPTION OF THE INVENTION

Embodiments of a display device for a conveyor according to the present invention are described below with reference to the drawings.

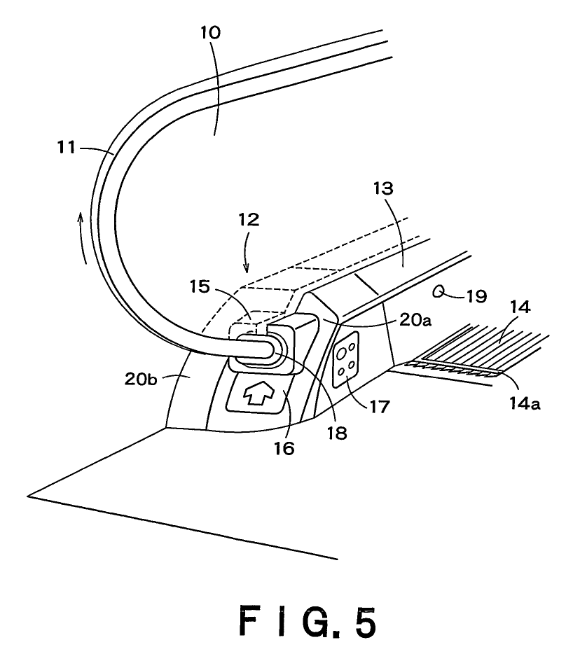

FIG. 5 shows a platform and its vicinity of an escalator to which the present invention is applied. In FIG. 5, the reference number 10 indicates an end part of a handrail panel. A handrail panel of an escalator can be formed of a plate glass or a stainless plate, both of which the present invention can be applied to. FIG. 5 shows a handrail panel end portion 10 of a left handrail panel relative to a platform, with a right handrail panel end portion being omitted. A handrail 11 is moved and folded back at the handrail panel end portion 10 to turn its advancing direction. The reference number 12 indicates an end skirt portion as a whole. The end skirt portion 12 is mounted on each end of a deck cover 13. A step is indicated by the reference number 14. A yellow demarcation line 14a is applied to a periphery of a surface of the step 14.

A belt entrance 15 is formed on a front surface of the end skirt portion 12. A display device 16 is attached below the end skirt portion 12 to display operation conditions of the escalator such as a moving direction. The display device 16 may either be disposed on both of the end skirt portions 12 on both sides of the platform, or may be disposed on one of the end skirt portions 12.

Various switches and auxiliary instruments such as an operation board 17, an inlet switch 18, a passenger detection sensor 19 of the elevator are disposed on an inside surface of the end skirt portion 12 where an operating function and a safety function are concentrated.

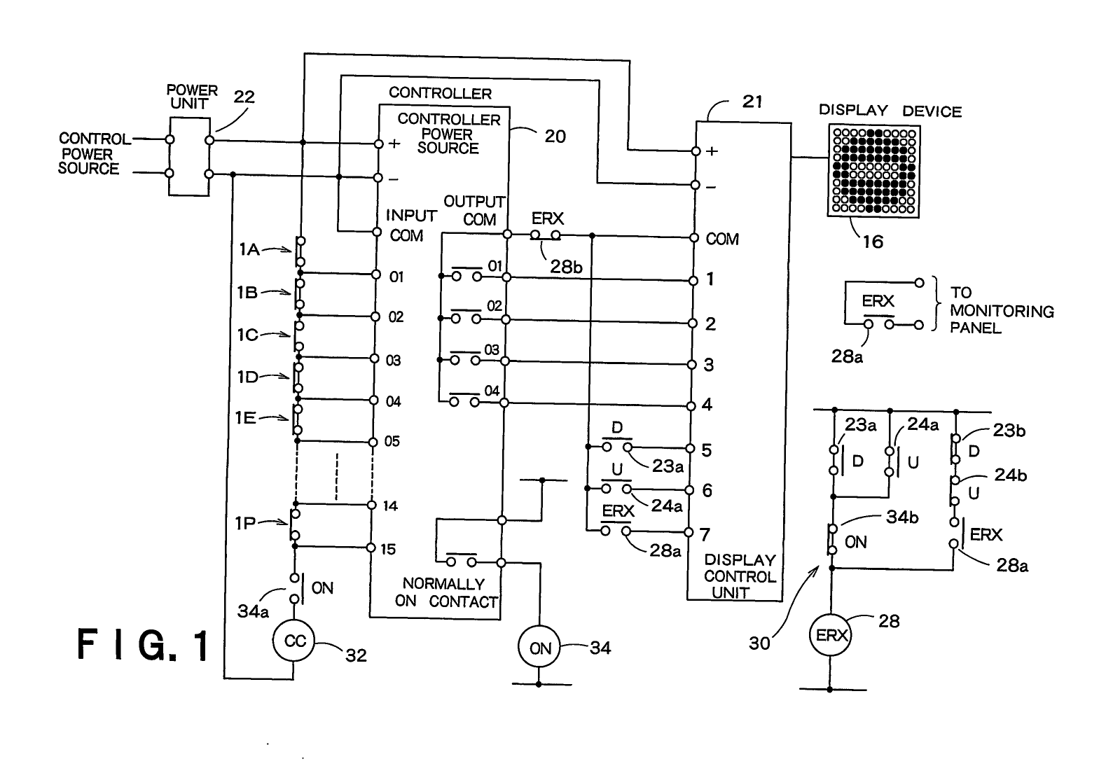

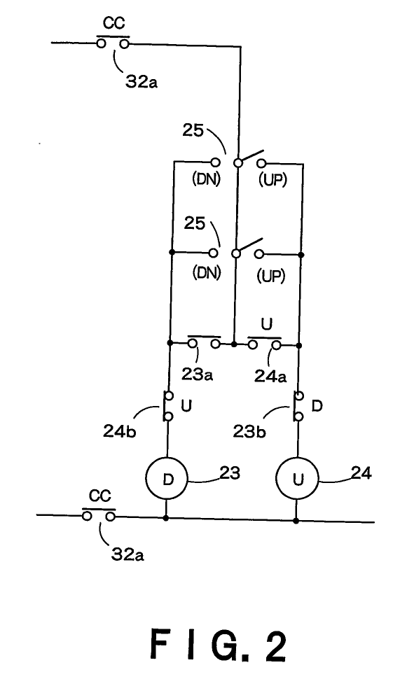

FIG. 1 is a circuit diagram of an operation condition display apparatus of the embodiment. FIG. 2 shows contactors disposed on a switch circuit of a motor driving circuit for a crive motor of the escalator.

In FIG. 1, the reference number 20 indicates a controller for controlling an operation of the escalator, while the reference number 21 indicates a display controller for controlling the display apparatus 16. A power unit is indicated by the reference number 22. In FIG. 2, the reference numbers 23 indicates a contactor for switching an operation of the escalator to a DOWN move, while the reference number 24 indicates a contactor for switching an operation of the escalator to an UP move. The reference number 25 Indicates a switch for switching the DOWN move to the UP move and vice versa. When the switch 25 is changed to an UP position, the UP operation contactor 24 becomes ON whereby an a contact 24a of the UP operation contactor 24 becomes ON and a b contact 24b thereof becomes OFF. Thus, the DOWN operation contactor 23, which has been ON until then, becomes OFF. When the switch 25 is switched on a DOWN position, the proceedings are reversely carried out.

In FIG. 1, the reference numbers 1A to 1P indicate contacts of safety devices that are disposed on various points of the escalator. The contacts 1A to 1P of the safety devices are constructed as b contacts which are opened when the safety devices are actuated. The contacts 1A to 1P of the safety devices are respectively connected in parallel to input ports #1 to #15 of the controller 20. Contacts #1 to #4 are connected in parallel to output ports #1 to #4 of the controller 20. ON/OFF signals of the contacts are respectively transmitted to input ports #1 to #4 of the display control unit 21.

In the display control unit 21, an a contact 23a of the DOWN operation contactor 23 is connected to an input port #5 of the display control device 21, the a contact 24a of the UP operation contactor 24 is connected to an input port #6 thereof, and an a contact 28a of a detection relay 28 for detecting an malfunction of the controller, which is described in detail below, is connected to an input port #7 thereof. These contacts are connected to the respective input ports in parallel to a wiring connecting an output COM port of the controller 20 to an input COM port of the display control unit 21.

In FIG. 1, the reference number 30 indicates a malfunction detection circuit including the controller malfunction detecting relay 28. The a contact 28a of the controller malfunction detecting relay 28 is disposed on the wiring junction in which the output COM port of the controller 20 is connected to the input COM port of the display control device 21, and on a power supply circuit of a monitoring panel. The reference number 32 indicates a safety device detection relay. An a contact 32a of the safety device detection relay 32 is disposed on a switch circuit of the motor driving circuit shown in FIG. 2. When any of the safety devices is actuated, the a contact 32a makes the contactors 23 and 24 off. The reference number 34 indicates a normally ON relay which maintains an ON position as long as the controller 20 is normally operated.

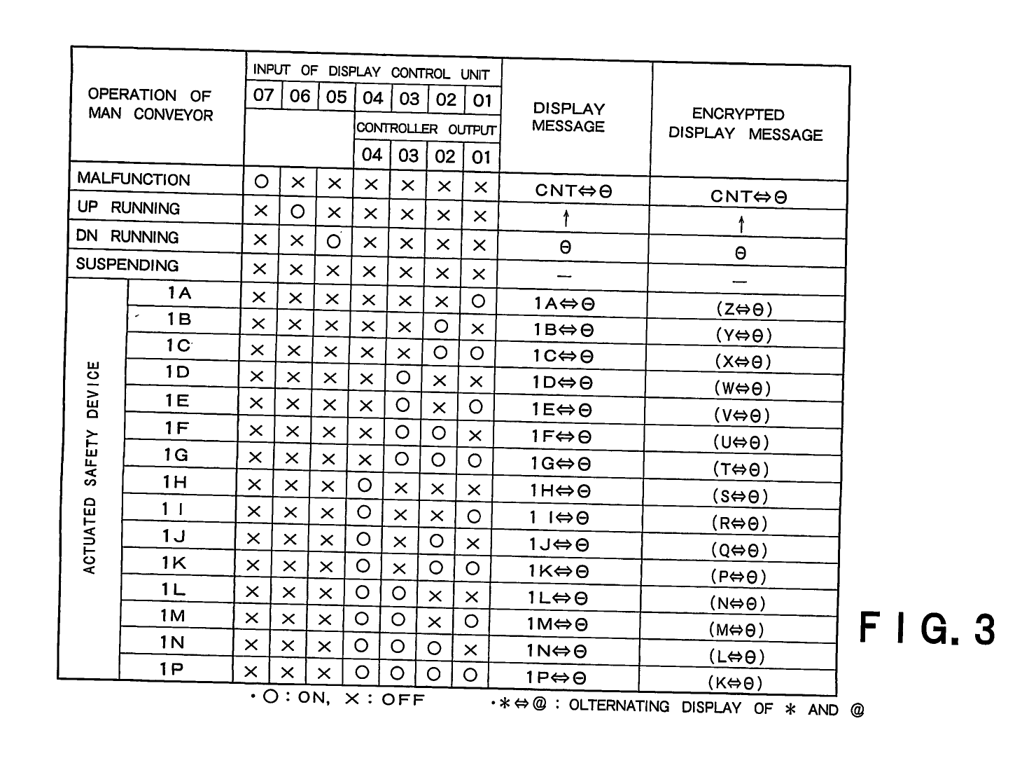

An process for displaying operation conditions of the escalator is described with reference to FIGS. 1 to 3. FIG. 3 is a reference chart showing a relationship between input signals fed to the display control unit 21 and messages to be displayed.

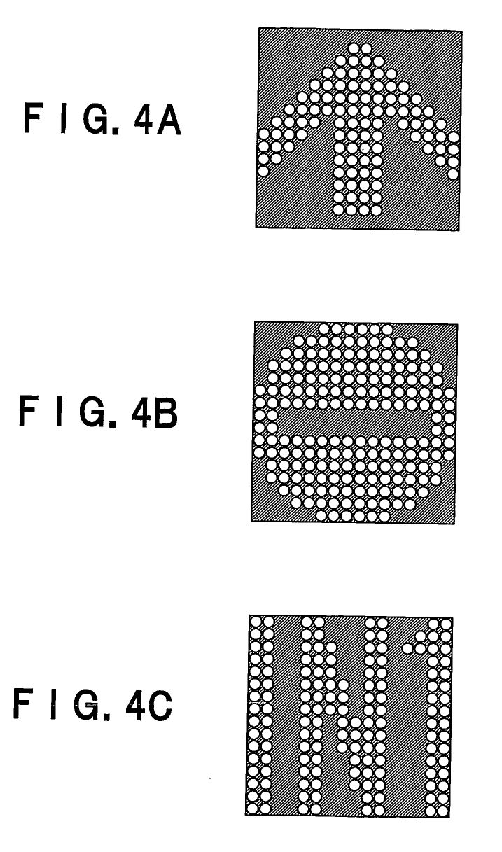

When the escalator is running in an upward direction, the UP operation contactor 24 is ON. In FIG. 1, since the a contact 24a of the UP operation contactor 24 connected to the input port #6 of the display control unit 21 is ON, the input port #6 is ON. While an operation of the escalator is suitably carried out and none of the safety devices 26A to 26P are actuated, potentials of the input ports #1 to #15 of the controller 20 are all ON at the H level. Based on the input information, the controller 20 switches off the output ports #1 to #4, as shown in the reference chart of FIG. 3. Thus, only the input port #6 of the display control unit 21 is ON and other input ports are OFF. Then, the display control unit 21 causes the display device 16 to indicate an arrow mark shown in FIG. 4(a) representing that the escalator is available.

When the escalator is running in a downward direction, the a contact 23a of the DOWN operation contactor 23 is ON, and only the input port #5 of the display control unit 21 is ON while all the other input ports are OFF. In this case, the display device 16 indicates a mark shown in FIG. 4(b) representing a forbiddance of entering the escalator.

A display operation upon an operation of the safety devices in the course of the upward operation is described. Suppose that any of the safety devices is actuated to cause the contact 1A to become OFF. Since an opening of the contact 1A causes the safety device operation detection relay 32 to become OFF, the a contact 32a shown in FIG. 2 is opened so that the contactor 24 becomes OFF. As a result, an running operation of the escalator is stopped.

In the controller 20, since the contact 1A is opened, potentials of the input ports #1 to #15 are all OFF at the L level. As shown in FIG. 3, the controller 20 switches on the output port #1 based on the input information. Thus, only the input port #1 of the display control unit 21 becomes ON. In compliance with the chart of FIG. 3, the display control device 21 receiving the same signal causes the display device 16 to alternately display a mark shown in FIG. 4(c) representing a position of the actuated safety device and the mark shown in FIG. 4(b) representing a forbiddance of entering, with certain intervals therebetween.

Similarly, when the contact 1B of the safety devices is actuated, only the input port #1 of the controller 20 becomes ON. As shown in FIG. 3, when such a signal is introduced, the controller 20 makes only the output port #2 ON. The display control unit 21 receiving the same signal causes the display device 16 to display a predetermined message in compliance with the chart of FIG. 3

In this way, the controller 20 converts information denoting an actuation of any of the safety devices 1A to 1P to 2₄ patterns of binary signals formed by a combination of ON/OFF of the four input ports #1 to #4, and outputs the binary signals to the display control unit 21. In the display control unit 21, inputs provided from the controllers 20 are assigned to the input ports #1. to #4, while ON/OFF signals of the respective contacts of the DOWN operation contactor 23, the UP operation contactor 24, and the controller malfunction detection relay 28 are transmitted to the input ports #5 to #7. As a result, as shown in FIG. 3, when ON/OFF combinations are previously set, it is possible for the display device 16 to display messages corresponding to all the operations.

A display operation when the controller 20 is not normally operated is described.

The normally ON relay 34 maintains an ON position as long as the controller 20 is working. However, when the controller 20 is failed for some reason, an always ON contact of the always ON relay 34 becomes OFF.

In the malfunction detection circuit 30 on which the controller malfunction detection relay 28 is disposed, a b contact 34b of the always ON relay 34 becomes ON whereby the controller malfunction detection relay 28 becomes ON. At the same time, in an input portion of the controller 20, an a contact 34a of the normally ON relay 34 becomes OFF whereby the safety device detection relay 32 becomes OFF. Accordingly, the DOWN operation contactor 23 or the UP operation contactor 24 becomes OFF to thereby immediately stop a running operation of the escalator.

In the controller malfunction detection circuit 30, since the a contact 23a of the DOWN operation contactor 23 or the a contact 24a of the UP operation contactor 24 becomes OFF, the controller malfunction detection relay 28 is self-maintained.

The self-maintaining of the controller malfunction detection relay 28 maintains an opened position of the b contact 28b of the controller malfunction detection relay 28 which is disposed on the wiring connecting the COM output port of the controller 20 to the COM input port of the display control unit 21. Thus, an input from the controller 20 to the display control unit 21 is interrupted. Accordingly, wrong messages irrelevant to the present running condition, which may be caused based on a signal from the malfunctioned controller 20, are prevented from being displayed. That is, since the a contact 28a of the controller malfunction relay 28 is ON, only the input port #7 of the input ports #1 to #7 of the display control unit 21 is ON. In compliance with the chart of FIG. 3, the display device 16 alternately displays characters “CNT” representing that the controller 20 is failed, and a mark representing a forbiddance of entering.

On the other hand, since the a contact 28a of the controller malfunction detection relay 28 disposed on a circuit of the monitoring panel becomes ON, a outbreak of the malfunction is displayed on the monitoring panel. Consequently, an operator can surely be aware of the malfunction of the controller 20.

In the above embodiment, the display device 16 displays messages corresponding to the operation conditions of the safety devices in compliance with the chart of FIG. 3. Alternatively, as shown in the rightmost column in the chart of FIG. 3, encrypted characters and marks relating to the operation conditions of the safety devices can be shown, whereby the displayed messages are comprehensible by only operators and maintenance workers. Thus, details of breakdown are not understood by outsiders, which can ease the anxiety of passengers.

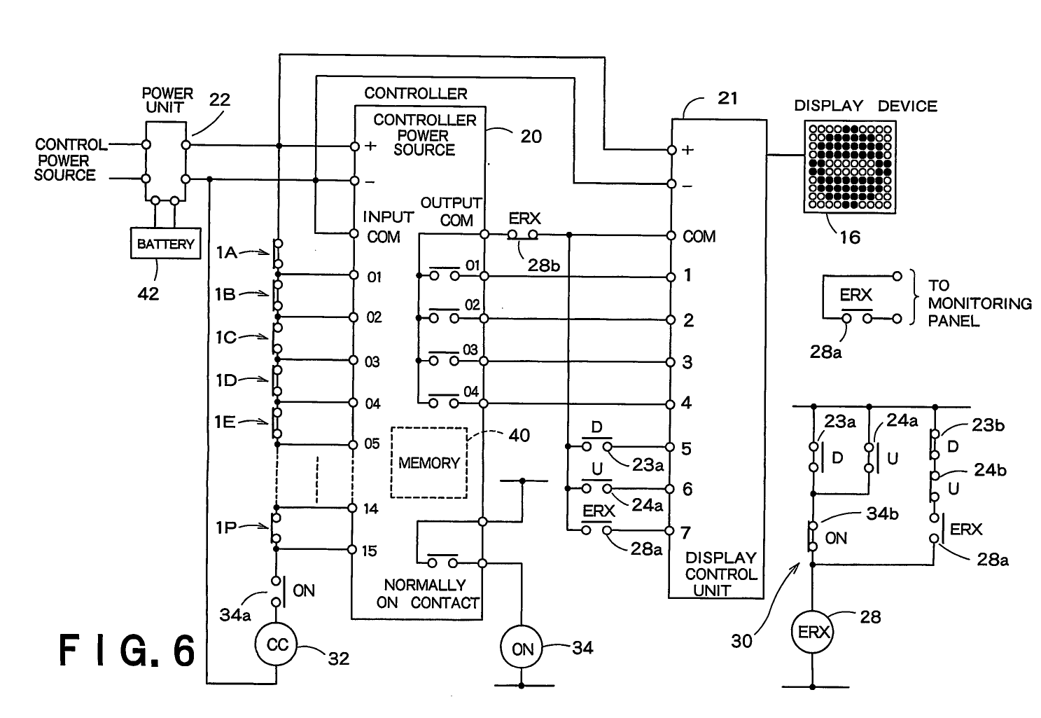

A second embodiment of the present invention is described with reference to FIG. 6.

According to the second embodiment, a memory 40 of the controller 20 stores malfunction history data in the past fes years. Thus, the malfunction history data stored in the memory 40 can be utilized when the escalator is maintained.

The power unit 22 is provided with a battery 42. Thus, if a customer power source is blocked, an electric power necessary to display a malfunction of the controller 20 can be reserved by using the battery 42. Consequently, when the customer power source is blocked, the memory 40 of the controller 20 stores new breakdown history data, which can facilitate a work for restoration of the elevator.

1. A display apparatus for a conveyor comprising:
a plurality of safety devices disposed on a conveyor;
a display configured to indicate information relating to operational conditions of the conveyor or positions of a malfunctioned safety device;
a contactor for intermittently charging to a motor driving circuit of the conveyor, or changing running operation between normal and reverse running directions;
a safety device detector configured to be capable shutting down a power source of the contactor, when any of the safety devices is actuated; and
a display controller configured to specify the operation condition of the conveyor or the actuated safety device, and providing the information to the display.

2. A display apparatus for a conveyor comprising:
a plurality of safety devices disposed on a conveyor;
a display configured to indicate information relating to operational conditions of the conveyor or positions of a malfunctioned safety device;
a contactor for intermittently charging to a motor driving circuit of the conveyor, or changing running operation between normal and reverse running directions;
a safety device detector configured to be capable shutting down a power source of the contactor, when any of the safety devices is actuated;
a binary signal means configured to generate a binary signal which specifies the operation condition of the conveyor or the actuated safety device; and
a display controller configured to determine a indication to be displayed in compliance with a combination of introduced binary signals, and providing the display signal to the display.

3. The display device for a conveyor according to claim 2, wherein
the binary signal means includes a controller for outputting to the display controller the binary signals specifying the position of actuated safety device based on potentials of the respective safety devices, the controller also serving for controlling an operation of the conveyor; and a contact which is opened and closed in conjunction with ON/OFF of the contactor, and is connected to an input of the display controller.

4. The display device for a conveyor according to claim 3 further comprising:
a signal interrupting means for interrupting all the signals to be delivered to the display controller, upon a detection of a malfunction of the controller.

5. The display device for a conveyor according to claim 4, wherein
the signal interrupting means sends a signal informing of an occurrence of the malfunction to a monitoring panel, simultaneously with interrupting the signals introduced to the display controller.

6. The display device for a conveyor according to claim 1 or 2, wherein
the display controller has a function for encrypting a indication to be displayed.

7. The display device for a conveyor according to claim 3, wherein
the controller has a storing means for storing malfunction history data.

8. The display device for a conveyor according to claim 7, wherein
the controller has a battery as an emergency power source.

9. The display device for a conveyor according to claim 1 or 2, wherein
the display device is disposed below an entrance of a handrail at an end of a handrail panel.

10. The display device for a conveyor according to claim 9, wherein
an operation panel is disposed near the display device.
